(19) United States
(12) Patent Application Publication
(10) Pub. No.: US 2005/0023321 A1
(43) Pub. Date: Feb. 3, 2005

(54) Double trigger electric stapler

(76) Inventor: Eric Tsai, Ta-Li City (TW)

Correspondence Address: DELLETT AND WALTERS, P. O. BOX 2786, PORTLAND, OR, 97208-2786, US

(21) Appl. No.: 10/632,497

(22) Filed: Jul. 31, 2003

(51) Int. Cl. B25C 1/00

(52) U.S. Cl. 227/78; 227/120

(57) ABSTRACT

A double trigger electric stapler includes a body, a stapling mechanism and a control circuit device. The body has a front and a stapling recess defined in the front. The stapling mechanism and the control circuit device are respectively mounted in the body. The control circuit device connects electrically to the stapling mechanism and has a switch to control stapling. The switch can be a photoelectric switch and has a U-shaped trigger mounted transversally in the stapling recess. Therefore, a person can push pieces of paper into the stapling recess to touch the trigger to staple without any limitation regarding orientation. Using the electric stapler is convenient for both right-handed and left-handed people.

### BACKGROUND OF THE INVENTION

1. Field of the Invention

The present invention relates to an electric stapler, and more particularly to an electric stapler that can be triggered to staple paper from either side of the electric stapler.

2. Description of Related Art

With reference to FIG. 5, a conventional electric stapler (not numbered) comprises a base assembly (60), a housing (61) and a stapling mechanism (62). The base assembly (60) has a base (not numbered), a control circuit (not shown), a switch (not shown) and a trigger (63). The base has a front (not numbered), a top (not numbered) and a cavity (not shown). The top of the base has an elongated slot (not numbered) defined through the top. The control circuit is mounted in the cavity in the base and electrically connects to the stapling mechanism (62) that is mounted in the housing (61). The switch is a limit switch and is mounted in the cavity in the base and connects electrically to the control circuit. The trigger (63) is connected to the switch and has an outside end (not numbered) extending out through the elongated slot.

The housing (61) has a front recess (611), a bottom edge (not numbered) and an upper cavity (not numbered). The bottom edge attaches to the base, the front recess (611) exposes the stapling mechanism (62) and the top of the base, the elongated slot and the trigger (63). The stapling mechanism (62) is mounted in the upper cavity in the housing and has a staple driver solenoid (not shown) and a metal staple driver (not shown). The staple driver solenoid is mounted around the metal staple driver and connects electrically to the control circuit in the base assembly (60). To staple pieces of paper (not shown) together, the pieces of paper are pushed into the front recess (611) to touch and push the trigger (63) to activate the switch. The control circuit energizes the staple driver solenoid that produces an electromagnetic force that drives the metal staple driver downward. The moved staple driver will strike and drive a staple through the paper.

However, the conventional electric stapler only has a single trigger (63) that is typically located at the right side of the base. The pieces of paper must be pushed straight into the front recess (611) so the paper strikes the trigger (63). However, the one-sided trigger (63) does not allow a person to staple pieces of paper together at a corner. Therefore, application of the conventional electric stapler is limited. Operation of the conventional electric stapler is particularly inconvenient for a left-handed person, because the trigger (63) is typically located at the right side of the base.

Because the conventional electric stapler uses the limit switch to trigger the staple driver solenoid, activating the limit switch often requires a larger force to push the trigger (63). When only two or three pieces of paper are stapled together, the paper cannot smoothly push the trigger (63). Therefore, operation of the conventional electric stapler is also inconvenient when only a few pieces of paper are stapled together.

To overcome the shortcomings, the present invention provides an electric stapler having a double trigger to mitigate or obviate the aforementioned problems.

### SUMMARY OF THE INVENTION

The main objective of the invention is to provide an electric stapler that allows pieces of paper to be stapled in arbitrary ways such that the electric stapler is convenient to use for both right-handed and left-handed people.

Other objectives, advantages and novel features of the invention will become more apparent from the following detailed description when taken in conjunction with the accompanying drawings.

### BRIEF DESCRIPTION OF THE DRAWINGS

FIG. 1 is a side plan view in partial section of an electric stapler in accordance with the present invention;

FIG. 2 is an enlarged perspective view of a stapling recess in the electric stapler in FIG. 1;

FIG. 3 is an exploded perspective view of a photoelectric switch in the electric stapler in FIG. 1;

FIG. 4 is an operational perspective view of the electric stapler in FIG. 1; and

FIG. 5 is a perspective view of a conventional electric stapler in accordance with the prior art.

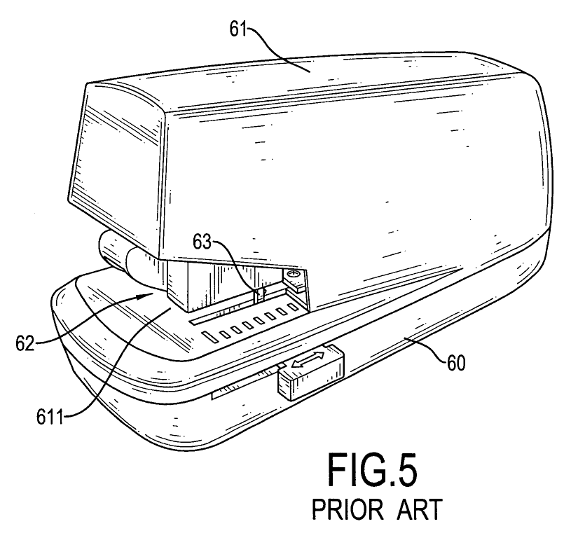

### DETAILED DESCRIPTION OF PREFERRED EMBODIMENT

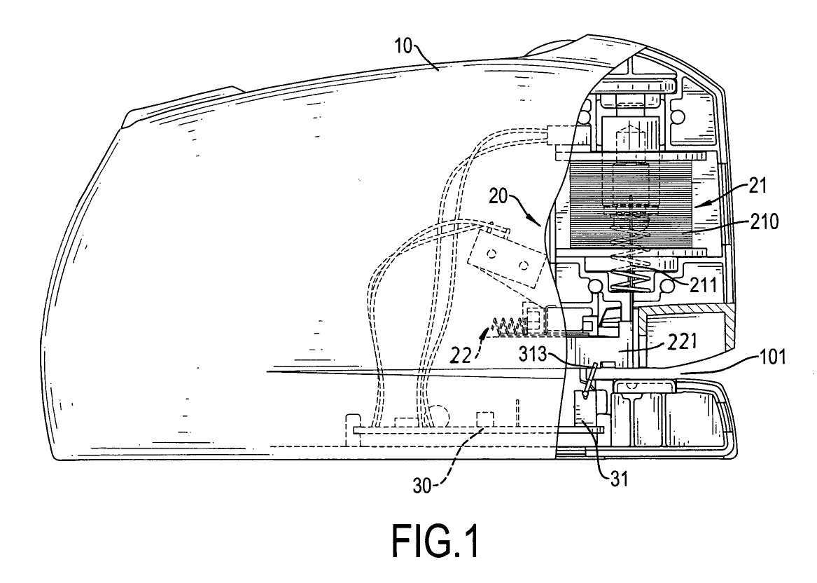

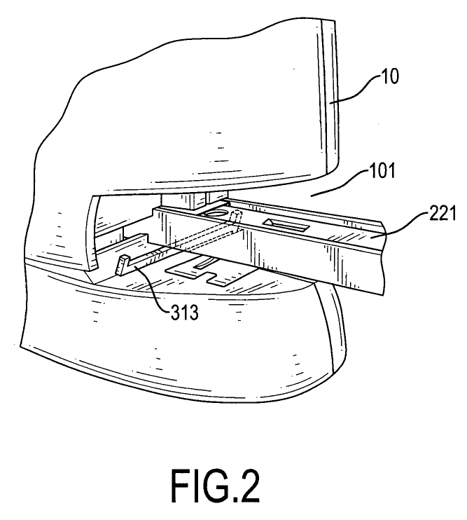

With reference to FIGS. 1 and 2, an electric stapler (not numbered) in accordance with the present invention comprises a body (10), a stapling mechanism (20) and a control circuit device (30). The body (10) has a front (not numbered), a left side (not numbered), a right side (not numbered), an interior cavity (not numbered) and a stapling recess (101). The stapling recess (101) is defined through the front.

The stapling mechanism (20) is conventional, is mounted in the interior cavity of the body (10) and has a staple driver solenoid (21) and a staple magazine (22). The staple driver solenoid (21) has a coil (210) and a metal staple driver (211). The coil (210) connects electrically to and is selectively energized by the control circuit device (30). The metal staple driver (211) has a bottom end (not numbered), is movably mounted in the coil (210) and moves downward when the coil (210) is energized.

The staple magazine (22) holds and indexes staples (not shown) to be stapled and has a track (221) slidably mounted in the stapling recess (101) in the body (10) on which staples are mounted. When the track (221) is pushed into the stapling recess (101), a staple on the outermost end of the track (221) is aligned with the bottom end of the metal staple driver (211). Therefore, the downward movement of the metal staple driver (211) can drive a staple through multiple pieces of paper and fasten them together.

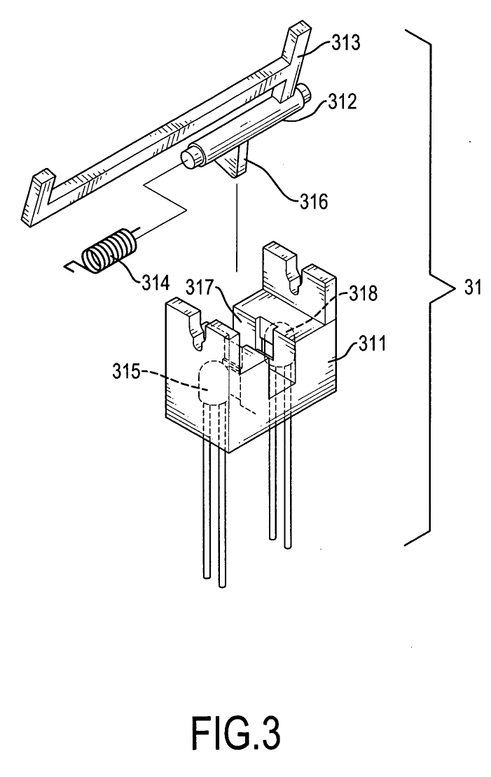

With reference to FIGS. 2 and 3, the control circuit device (30) is conventional and has a switch (not numbered) such as a conventional photoelectric switch (31) and a circuit board (not numbered). The photoelectric switch (31) comprises a mounting bracket (311), a pivot cylinder (312), a trigger (313), a torsional spring (314), a photoelectric detector (315) and a photoelectric emitter (318).

The mounting bracket (311) is mounted on the circuit board and has a transverse slot (317), a first window (not numbered) and a second window (not numbered). The transverse slot (317) has two opposite sidewalls (not numbered). The two windows are defined respectively through the sidewalls and are aligned with each other. The photoelectric detector (315) and the photoelectric emitter (318) are mounted in the mounting bracket (311) respectively behind the windows, connected electrically to the circuit board and correspond to each other through the windows. Therefore, lights produced by the photoelectric emitter (318) will be detected by the photoelectric detector (315) to produce an electric current transmitted to the circuit board.

The pivot cylinder (312) is pivotally mounted on the mounting bracket (311) with the torsional spring (314) that will provide a restitution force to return the pivot cylinder (312) to an upright rest position. The pivot cylinder (312) has a bottom blade (316) movably mounted in the transverse slot (317) between the photoelectric emitter (318) and the photoelectric detector (315) to block the transmission of light. When the pivot cylinder (312) is pivoted, the bottom blade (316) will be pivoted and allow the light produced by the photoelectric emitter (318) to be sensed by the photoelectric detector (315). When the photoelectric detector (315) detects the light, the photoelectric detector (315) produces an electric current and sends a trigger signal to the control circuit device (30) to energize the coil (210). The energized coil (210) will produce an electromagnetic force to drive the metal staple driver (211) to staple paper under the metal staple driver (211).

The trigger (313) is U-shaped and has a cross bar (not numbered), two parallel arms (not numbered) and a bottom coupling (not numbered). The cross bar is transversely mounted in the stapling recess (101) from the left side to the right side of the body (10) and has a proximal end (not numbered) and a distal end (not numbered). The arms are formed respectively at the ends of the cross bar and are perpendicular to the cross bar. The bottom coupling is formed at proximal end of the cross bar and is connected to the pivot cylinder (312).

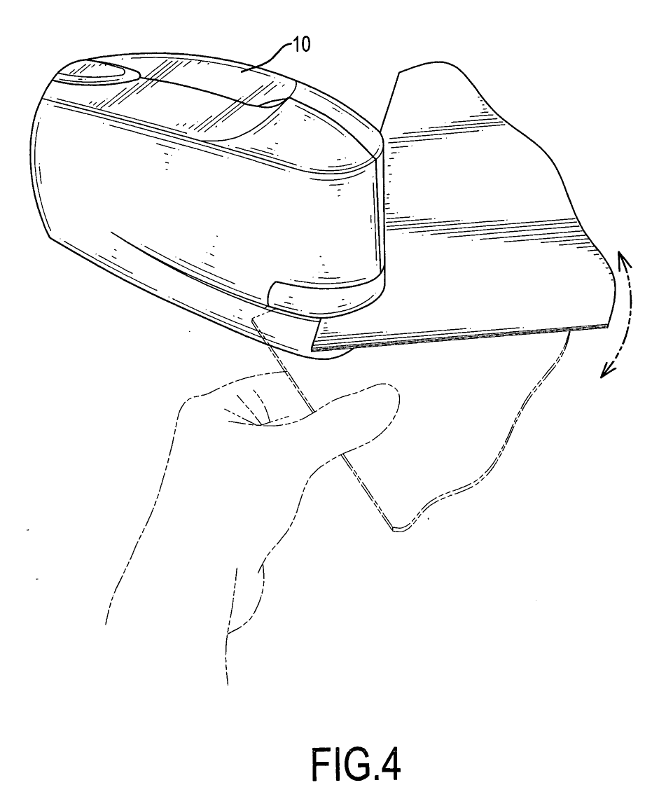

With reference to FIGS. 1, 3 and 4, pieces of paper can be pushed into the stapling recess (101) from any direction relative to the stapling recess (101) to strike either the cross bar or the parallel arms of the trigger (313). Thereafter, the trigger is pivotally rotated to drive the pivot cylinder (312) to rotate, and the bottom blade (316) is moved away from the transverse slot (317) to activate the photoelectric switch (31) to operate the stapler. Operating the electric stapler in accordance with present invention is convenient even for left-handed people, because the paper can be pushed into the stapling recess (101) in any orientation to touch the trigger (313) to switch on the photoelectric switch (31). If there are only two or three pieces of paper being inserted into the stapling recess (101) to strike the trigger (31), a large force to push the trigger (31) is not required. Because to push the trigger (31) to rotate only needs a force for overcoming the restitution force caused by the torsional spring (314), the torsional spring (314) can be selected to a suitable one that produces a smaller restitution force. Therefore, the electric stapler in accordance with the present invention will staple smoothly a few of paper together.

When the photoelectric switch (31) is switched on, the control circuit device (30) will energize the coil (210) and drive the staple driver (211) to staple the paper. Consequently, the shortcomings of the conventional electric stapler will be overcome by the stapler in accordance with present invention that is really convenient for both the right-handed and left-handed people.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A double trigger electric stapler comprising:
a body having a front, a left side, a right side and a stapling recess defined through the front;
a stapling mechanism mounted in the body and having a staple driver solenoid and a staple magazine, the staple driver solenoid having a coil and a metal staple driver movably mounted in the coil to be moved downward, the staple magazine having a track mounted movably in the stapling recess and aligned with the metal staple driver; and
a control circuit device mounted in the body, connecting electrically to the coil to energize the coil and having a switch and a circuit board, the switch connected electrically to the circuit board and having a U-shaped trigger, the trigger having a cross bar and two parallel arms, the cross bar mounted transversally in the stapling recess under the track and having a proximal end and a distal end, and the parallel arms formed respectively at the proximal and the distal ends of the cross bar.

2. The double trigger electric stapler as claimed in claim 1, wherein the switch is a photoelectric switch and comprises:
a mounting bracket mounted on the circuit board and having a transverse slot, a first and a second window, the transverse slot having two opposite sidewalls, and the first and the second windows defined respectively through the sidewalls and aligned with each other;
a photoelectric detector mounted in the mounting bracket and corresponding to the first window;
a photoelectric emitter mounted in the mounting bracket and corresponding to the second window;
a pivot cylinder pivotally mounted on the mounting bracket and having a bottom blade movably mounted in the transverse slot between the windows; and
a torsional spring mounted between the mounting bracket and the pivot cylinder to provide a restitution force to return the pivot cylinder to an upright rest position;
wherein the trigger is connected to the pivot cylinder.

3. The double trigger electric stapler as claimed in claim 2, wherein the trigger further has a bottom coupling formed downward at the proximal end of the cross bar and the bottom coupling is connected to the pivot cylinder to pivot the pivot cylinder.
